(19) United States
(12) Patent Application Publication
(10) Pub. No.: US 2017/0257848 A1
(43) Pub. Date: Sep. 7, 2017

(54) Measurement-relates signaling for wireless communication

(71) Applicant: TELEFONAKTIEBOLAGET LM ERICSSON (PUBL), Stockholm (SE)

(72) Inventors: Jonas Fröberg Olsson, LJUNGSBRO (SE); Jung-Fu Cheng, FREMONT, CA (US); Håkan Andersson, LINKOPING (SE)

(21) Appl. No.: 15/062,813

(22) Filed: Mar. 7, 2016

(51) Int. Cl. H04W 72/04

(52) U.S. Cl. CPC H04W 72/042

(57) ABSTRACT

The present disclosure pertains to a method for operating a radio node in a wireless communication network. The method comprises transmitting a carrier aggregate indication (CAI) indicating a carrier aggregation arrangement for measurement-related operation. The carrier aggregation arrangement represents a plurality of terminals configured for carrier aggregation and/or of at least one subset of a plurality of subsets of a set of carriers configured for carrier aggregation.

### TECHNICAL FIELD

The present disclosure generally pertains to communication in a wireless communication network, which in particular may utilize carrier aggregation.

### BACKGROUND

Carrier aggregation, e.g. in LTE, allows the combination of multiple carriers into a carrier aggregate or aggregation, e.g. to provide higher data transfer rates in wireless communication. For some applications, next to carriers in a licensed spectrum (licensed carrier), one or more carriers in an unlicensed spectrum (unlicensed carrier) may be used—Such carriers are for example often used in WiFi connections. Access to unlicensed carriers often requites different procedures from access to licensed carriers (e.g., using LBT procedures). While in common concepts, carrier aggregation allows a low number of carriers (e.g., up to 5) to be aggregated, the development of techniques for larger aggregates (e.g., comprising more than 5 component carriers in a carrier aggregate) is ongoing. With the use of different types of carriers and the increased number of carriers, controlling the quality of communication (e.g. via CSI reports or DCI) becomes more difficult, in particular if multiple terminals or user equipments are involved.

### SUMMARY

The present disclosure provides approaches to allow more efficient control of communication in particular for carrier aggregation scenarios, in particular regarding channel state information (CSI).

There is disclosed a method for operating a radio node in a wireless communication network. The method comprises transmitting a carrier aggregate indication, CAI, indicating a carrier aggregation arrangement for measurement-related operation. The carrier aggregation arrangement represents a plurality of terminals configured for carrier aggregation and/or of at least one subset of a plurality of subsets of a set of carriers configured for carrier aggregation.

Moreover, there is disclosed a method for operating a terminal in a wireless communication network. The method comprises obtaining a carrier aggregate indication, CAI, indicating a carrier aggregation arrangement for measurement-related operation. The carrier aggregation arrangement represents a plurality of terminals configured for carrier aggregation and/or of at least one subset of a plurality of subsets of a set of carriers configured for carrier aggregation.

There may also be considered a radio node for a wireless communication network. The radio node is adapted for, and/or comprises a transmitting module for, transmitting a carrier aggregate indication, CAI, indicating a carrier aggregation arrangement for measurement-related operation. The carrier aggregation arrangement represents a plurality of terminals configured for carrier aggregation and/or of at least one subset of a plurality of subsets of a set of carriers configured for carrier aggregation.

A terminal for a wireless communication network is also suggested. The terminal is adapted for, and/or comprises an obtaining module for, obtaining a carrier aggregate indication, CAI, indicating a carrier aggregation arrangement for measurement-related operation. The carrier aggregation arrangement represents a plurality of terminals configured for carrier aggregation and/or of at least one subset of a plurality of subsets of a set of carriers configured for carrier aggregation.

A plurality of terminal may generally comprise 2 or more terminals. It may be considered that the plurality of terminals represents a subset of a set of terminals, which may be terminals configured for carrier aggregation, in particular for carrier aggregation with the radio node. The plurality of terminals may be indicated by an index or one or more bits of a bit map. The plurality of subsets may comprise at least 4 subsets, which may be different from each other. The at least one subset may be one (and/or a selected one and/or a subset indicated by the CAI) of the plurality of subsets. The carriers of the set of carriers configured for carrier aggregation may be configured for the radio node and/or terminal, in particular for wireless communication between the terminal and the radio node. The subset may be indicated by an index or two or three or more bits of a bit map. The CAI may comprise the index or bit/s indicating the plurality of terminals and/or the index or bits indicating the subset of carriers, e.g. in a terminal field (also referred to as UE field) and a subset field (which may be represented by a CAI field or CSI field or corresponding request field).

The terminal may perform a measurement-related operation based on the CAI obtained, and/or be adapted for, and/or comprise a measurement module for, performing such. Obtaining a CAI may comprise receiving and/or determining the CAI. Receiving may in particular receiving a CAI transmitted by a radio node. Determining the CAI may comprise determining the CAI indirectly, e.g. on information available to the terminal.

According to the approaches described herein, a plurality (2 or more) of different terminals or different subsets (in particular, more than three different subsets) may be addressed or polled for measurement-related operation.

Generally measurement-related operation may be operation performed by a terminal. Measurement-related operation may comprise performing measurements, and/or determining and/or estimating channel state, and/or transmitting at least one measurement report, e.g. to a radio node or network. Determining and/or estimating a channel state may be based on measurement/s performed. A measurement report may be based on one or more measurements performed and/or on determined or estimated channel state. The measurements may be based on (and/or be performed on), and/or the measurement report may pertain to, reference signaling, e.g. cell-specific reference signaling, e.g. CRS reference signals, and/or CSI reference signals, and/or be performed on related resources, e.g. CSI resources. It may generally be considered that the CAI indicates one or more carriers on which and/or pertaining to which measurement-related operation is to be performed, e.g. by a terminal receiving the CAI and/or a terminal indicated by the CAI. Generally performing a measurement-related operation may be considered based on the CAI, if the terminal determines that it is addressed for measurement-related operation by the CAI and/or the carriers on which and/or pertaining to which the measurement-related operation are indicated by the CAI. It may generally be considered that the CAI indicates one or more cells associated to carriers, thus indicating the carriers (indirectly). The terminal may be assumed have available information , e.g. in one or more tables and/or according to a configuration, to map the cells to the carriers (or vice versa) as required. Thus, indicating one or more cells is a form of indicating one or more carriers.

CAI may comprise a pre-determined number of bits, e.g. in a CAI field. CAI may indicate a timing and/or periodicity for measurement-related operations to be performed on the at least one subset. Such timing may e.g. indicate periodic or aperiodic timing. Transmitting the CAI may comprise broadcasting and/or multicasting the CAI. In particular in cases in which the CAI indicates a plurality of terminals, this allows transmission with little overhead and with efficient use of transmission resources. Terminals addressed by the transmission may generally be terminals indicated by the CAI. A terminal may be adapted for, and/or comprise an identifying module for, and/or perform, determining, based on the received CAI, whether it is indicated for measurement-related operation, and/or on which subsets of carrier it has to perform measurement-related operation. It may generally be considered that transmitting the CAI comprises transmitting a measurement request, wherein the CAI may be considered part of the measurement request. A measurement request may be considered to represent configuration data and/or is used for configuring the terminal, in particular for measurements according to the measurement request. It may be considered that transmitting the CAI comprises transmitting DCI (Downlink Control Information), in particular according to a format as described herein). The DCI may comprise a CAI field having a pre-determined number of bits.

The at least one set of carriers configured for carrier aggregation may generally comprise 5 or more sets of carriers configured for carrier aggregation. Alternatively or additionally, the CAI may comprise 3 or more bits.

Further additionally or alternatively, the at least one set of carriers may represent carriers configured for one carrier aggregate, and/or the at least one set of carriers may comprise sets with different types of carriers. A carrier aggregate may generally refer to the carriers included in carrier aggregation for one terminal and/or for one primary cell.

There is also suggested a program product comprising instructions executable by control circuitry, the instructions causing the control circuitry to control and/or perform any one of the methods described herein when executing the instructions.

Moreover, there is described a storage medium readable by control circuitry, the storage medium storing any one of the program products described herein. A storage medium may be comprise any number of media and/or memories adapted for storing instructions and/or readable or accessible for control circuitry. Control circuitry and/or the storage medium may comprise corresponding or suitable interface/s. A storage medium may be volatile or non-volatile. Exemplary storage media may include random access memory, read-only memory, flash memory, optical memory, magnetic memory (e.g., a harddisc), etc.

Generally, the subsets of the at least one set of carriers and/or the plurality of of terminals may be configurable, in particular configurable independently of the transmission of CAI. It may be considered that the CAI indicates the carrier aggregation arrangement by indexing (e.g., in a table) a subset and/or a plurality of terminals. The radio node may perform, and/or be adapted for, and/or comprise a configuring module, for configuring the terminal. Configuring may comprise transmitting a measurement request and/or configuring the subsets, in particular using higher-level signaling, e.g. RRC (Radio Resource Control) signaling, wherein the subsets may be indicated or indictable by the CAI. Transmitting a measurement request and/or CAI may be performed after configuring the subsets, the radio node, and/or its configuring and/or transmitting module, may be adapted accordingly. Configuring a subset may comprise indicating, e.g. with configuration data, which carriers belong to the subset, e.g. by indexing and/or referencing them to a table available to the terminal. Such a table may be pre-configured, e.g. when a carrier aggregate is configured.

Different subsets may have at least one carrier different. The CAI may generally indicate at least a first subset, a second subset and a third subset. It may be considered that the CAI may indicate a fourth and optionally a fifth or sixth subset. A first and a second subset (and/or any number of the subsets above 2) may comprise (and/or consist of) S-Cells of a carrier aggregate, in particular different S-Cells. A subset may comprise one or more carriers. Generally, a serving cell may be a P-Cell or S-Cell, e.g. of a carrier aggregate. A serving carrier may be associated to a serving cell. Generally, each cell may comprise at least on downlink (DL) carrier, which may be an LBT or non-LBT carrier.

A set of carriers configured for carrier aggregation may comprise the carriers of, and/or a subset of the carriers of, a carrier aggregate, which may be configured for one or more than one terminals. A subset may comprise a part of, or all, of the carriers of a set.

Different types of carriers may in particular LBT carriers and non-LBT carriers (generally carriers for which no LBT procedure is to be performed for access, e.g. licensed carriers).

Generally, an approach or concept described comprises to modify an existing DCI format and add a new DCI format for CSI request so that CSI can be requested for individual S-cells, or more sets of S-cells, and multiple UEs can be polled using the same grant or transmission of a measurement request or DCI (Downlink Control Information). DCI may generally comprise a grant of resource to one or more terminals. A resource may in particular a time-frequency resource, e.g. for receiving or transmitting, allocated to the terminal or one of the terminals. A time-frequency resource for LTE may e.g. be represented by a Resource Block or Resource Block pair, or subdivisions thereof.

According to the approaches described herein, measurement reports (e.g., CSI) for individual S-cells or (subsets) of such cells may be obtained, thus enabling a scheduler to make more informed scheduling decisions and thereby increase data throughput and/or quality.

Another advantage is that multiple UEs, or sets of UEs, can be polled for CSI using a single grant, thus reducing signaling overhead.

### BRIEF DESCRIPTION OF THE DRAWINGS

The drawings are provided to elucidate the approaches described herein and are not intended to limit the scope of the disclosure.

The drawings comprise:

FIG. 1, showing an exemplary terminal;

FIG. 2, showing an exemplary radio node;

FIG. 3, showing an exemplary method for operating a radio node;

FIG. 4, showing an exemplary radio node;

FIG. 5, showing an exemplary method for operating a terminal; and

FIG. 6, showing an exemplary terminal.

### DETAILED DESCRIPTION

In the context of this specification, a wireless communication network may comprise one or more (radio) nodes or devices adapted for wireless and/or radio communication, in particular according to a pre-determined standard like LTE. It may be considered that one or more radio nodes are connected or connectable to a core network and/or other network nodes of the network, e.g. for transmission of data and/or control. A wireless communication system may comprise at least one radio node (which may be a base station or eNodeB), which may be connected or connectable to a core network, and/or may comprise and/or provide control functionality and/or at least one corresponding control node, e.g. for mobility management and/or data packet transmission and/or charging-related functionality. A radio node of the network may be considered a network node or radio network node. A radio node (network node) may in particular be a user equipment or a base station and/or relay node and/or micro-(or pico/femto/nano-)node of or for a network, e.g. an eNodeB.

A wireless device may generally be any device adapted for transmitting and/or receiving radio and/or wireless signals and/or data, in particular communication data, in particular on at least one carrier. Examples of wireless device comprise a terminal or a radio node. A terminal may be an end device terminating a communication. It may be considered that a terminal is a mobile or stationary user device or machine-type communication enabled device, e.g. a sensor device or production apparatus. A terminal may in particular be a user equipment (UE). It may be generally be considered that a terminal is adapted (and/or configured) for using, and/or uses transmission mode 10 (TM10) according to LTE for the one or more carriers i(and/or carrier aggregate) t is configured for.

A wireless device may generally comprise control circuitry and/or radio circuitry. It may be considered that a wireless device comprises, and/or is connected or connectable to, antenna circuitry. The latter may in particular the case for a radio node.

Generally, control circuitry may comprise integrated circuitry for processing and/or control, e.g. one or more controller/s and/or processor/s and/or processor core/s and/or microcontroller/s and/or FPGA/s (Field Programmable Gate Array) and/or ASIC/s (Application Specific Integrated Circuitry). Control circuitry may comprise and/or be connected to and/or be adapted for accessing (e.g. writing to and/or reading from) memory, which may comprise any kind of volatile and/or non-volatile memory, e.g. cache and/or buffer memory and/or RAM (Random Access Memory) and/or ROM (Read-Only Memory) and/or optical memory and/or EPROM (Erasable Programmable Read-Only Memory). Such memory may be adapted to store code executable by control circuitry and/or other data, e.g. data pertaining to communication, e.g. configuration/s and/or address data of nodes, etc. Control circuitry may be adapted to control any of the methods described herein and/or to cause such methods to be performed. Corresponding instructions may be stored in the memory, which may be readable and/or readably connected to the control circuitry.

Radio circuitry may comprise receiving circuitry (e.g. one or more receivers) and/or transmitting circuitry (e.g. one or more transmitters). Alternatively or additionally, radio circuitry may comprise transceiving circuitry for transmitting and receiving (e.g. one or more transceivers). It may be considered that radio circuitry comprises a sensing arrangement for performing LBT/CCA. Antenna circuitry may comprise one or more antennas or antenna elements, which may be arranged in an antenna array.

In many wireless communication systems, CSI (Channel-State Information) feedback is used for obtaining good performance. Reference signals are transmitted (e.g., downlink and/or from a radio node), which may be used to measure or estimate the channel state, e.g. pertaining to one or more carriers. A measurement report may comprise as parameters a CQI (Channel-Quality Indicator) and an RI (Rank Indicator). More detailed reports may include frequency-selective CQI and/or PMI (Pre-coding Matrix Indicator) information. Measurement-related operation may comprise determining, and/or a measurement report may comprise, CQI and/or RI and/or PMI. In particular CQI may be frequency (or carrier) dependent.

For example, LTE supports CSI-reporting schemes that rely on the reference symbols being transmitted periodically; the cell-specific reference symbols (CRS) are sent every subframe while CSI-RS can be sent with a larger periodicity. UEs or terminals using transmission mode 10 (TM10) rely solely on CSI-RS resources, while other terminals or Ues using other transmission modes may typically use the CRS at least for interference measurements.

TM10 UEs can be configured to report CSI for multiple CSI-processes, which each may have different CSI-measurement resources. A CSI-measurement resource consists of a CSI-RS resource and a CSI-IM (CSI interference measurement) resource. Both the CSI-RS and the CSI-IM resources are characterized (among other things) by a subframe configuration. The subframe configuration specifies a subframe periodicity and a subframe offset that specify for the UE at which time instances the respective measurement resources are available.

License-Assisted Access via LTE (LAA-LTE) has recently been proposed as a technology for co-existence on unlicensed carriers with, e.g., WiFi. An unlicensed carrier (named S-cell) is typically a carrier that needs to be shared by DL and UL, i.e., a TDD scheme typically needs to be applied. In some scenarios there may be a desire to use the S-cell for LTE DL traffic only, whereby the assisting (licensed) carrier (P-cell) is used to send UL control messages related to both the P-cell and the S-cell. In such solutions, the UCI (Uplink Control Information) of the S-cell is aggregated with the UCI of the P-cell. The UCI typically consists of DL Ack-Nack and measurement reports, e.g. CSI reports.

Also, other scenarios, e.g. standalone scenarios, where there is no assisting P-cell, there may be a desire to operate some S-cells in pure DL mode while other S-cells operate in UL mode. Also, for such scenarios, the UCI of the DL mode S-cells could be aggregated with the UCI of one or more UL mode S-cells. For UL grants with UE-specific search space, the CSI request (which may be considered an example of a measurement request) consists of a 2-bit field wherein the eNB can control which types of CSI the UE shall report.
“00”: No CSI request
“01”: CSI request for CSI process(es) of serving cell
“10”: CSI request for CSI process(es) of first set of serving cells
“11”: CSI request for CSI process(es) of second set of serving cells

Using this 2-bit field in the DCI format the eNB can thus obtain CSI from two (sub)sets of P-cell and S-cells. For example, the first (sub)set could be P-cell only and the second (sub)set could be all configured S-cells.

An UL grant format with CSI request bitmap for configured serving cells is discussed in the following. Such a grant may represent DCI and/or a measurement request allocating resource, in particular UL resource.

An UL grant format similar to Format 4 according to LTE may be defined. The format differs from Format 4 in the CSI request field (representing the CAI, and also reffered to as CAI field) consists of more than two bits.

The CSI request field could be defined according to table 1. The UL grant format may pertain to and/or transmitted on a Physical Downlink Control Channel (PDCCH) or an Enhanced Physical Downlink Control Channel (EPDCCH).

It should be noted that the sets referred to in the tables and the embodiments below represent subsets of the set of carriers configured for carrier aggregation, in particular pertaining to the terminal/s the DCI is to be transmitted. A CSI request may generally be seen as a measurement request or a specialised form of CAI.

TABLE 1
CSI Request field consisting of 3 bits for PDCCH/EPDCCH with
uplink DCI format (e.g., in UE-specific search space)

| Value of CSI | |
|---|---|
| request field | Description |
| ‘000’ | No aperiodic CSI report is triggered |
| ‘001’ | Aperiodic CSI report is triggered for serving cell c |
| ‘010’ | Aperiodic CSI report is triggered for a 1^{st} set of serving |
| | cells configured by higher layers |
| ‘011’ | Aperiodic CSI report is triggered for a 2^{nd} set of serving |
| | cells configured by higher layers |
| ‘100’ | Aperiodic CSI report is triggered for a 3^{rd} set of serving |
| | cells configured by higher layers |
| ‘101’ | Aperiodic CSI report is triggered for a 4^{th} set of serving |
| | cells configured by higher layers |
| ‘110’ | Aperiodic CSI report is triggered for a 5^{th} set of serving |
| | cells configured by higher layers |
| ‘111’ | Aperiodic CSI report is triggered for a 6^{th} set of serving |
| | cells configured by higher layers |

In some embodiments the CSI request field is defined as a bitmap, e.g., first bit is CSI request bit of first configured serving cell, second bit is CSI request bit of second serving cell, and so on. In such embodiments, the serving cell order may be defined by higher-layer signaling (e.g., by an RRC reconfiguration message received by UE). In other embodiments, the number of CSI request bits may be configured by higher layers.

A DCI format carrying pure CSI requests is discussed in the following.

A pure CSI request may be considered to be measurement request without resource allocation. In one exemplifying embodiment, a DCI format carries CSI requests for a set of terminals or UEs:
CSI request-M bits

For this embodiment, a terminal or UE may be configured to blindly decode (e)PDCCH for a specific RNTI, e.g., RNTI_csi_request. This enables the radio node or eNB to send CSI requests to a set of UEs using a single (e)PDCCH transmission.

In some embodiments, the first bit may correspond to a first terminal or UE index, the second bit corresponds to a second terminal or UE index. The UE index/indices may be signaled or configured to the terminal/s or UE/s via higher-layer signaling (e.g., RRC).

In other embodiments the M-bit CSI request field may be defined according to table 2

TABLE 2
CSI request field (M = 2).

| Value of CSI | |
|---|---|
| request field | Description |
| ‘00’ | Aperiodic CSI report is triggered for a 1^{st} |
| | set of UEs |
| ‘01’ | Aperiodic CSI report is triggered for a 2^{nd} |
| | set of UEs |
| ‘10’ | Aperiodic CSI report is triggered for a 3^{rd} |
| | set of UEs |
| ‘11’ | Aperiodic CSI report is triggered for a 4^{th} |
| | set of UEs |

In such embodiments the UE-sets are defined by higher-layer signaling.

In another exemplifying embodiment the M-bit CSI field is defined according to table 3.

TABLE 3
CS request field (M = 2) indicating
requests for sets of serving cells.

| Value of CSI | |
|---|---|
| request field | Description |
| ‘00’ | Aperiodic CSI report is triggered for a 1^{st} set |
| | of serving cells |
| ‘01’ | Aperiodic CSI report is triggered for a 2^{nd} set |
| | of serving cells |
| ‘10’ | Aperiodic CSI report is triggered for a 3^{rd} set |
| | of serving cells |
| ‘11’ | Aperiodic CSI report is triggered for a 4^{th} set |
| | of serving cells |

In such embodiments an UL grant for sending CSI request could be semi-statically configured for the UE. The grant may be configured as non-active until a UE receives a CSI request grant indicating which set of serving cells the UE shall report CSI for. For example, the semi-static grant preferably indicates resource block allocation, resource allocation type, cyclic shift, etc. but not the UL subframe the grant is valid for. The precise UL subframe that the semi-static grant should be applied to is indicated by the subframe in which the CSI request grant is received in. For example, if the CSI request grant is received in DL subframe n then the semi-static grant is valid for UL subframe n+4.

Alternatively, an UL grant may be sent using Format 4 and a CSI request grant specifying subsets of first and second sets of serving cells, respectively, as indicated in the Format 4 grant. In such embodiments, the two grants may specify that the UE shall report CSI for all serving cells in, e.g., the first set except those subsets specified by the CSI request grant.

In further other embodiments, the DCI format consists of an M-bit CSI request field and a K-bit UE index field:
CSI request-M bits
UE index bitmap-K bits

In some such embodiments
The first bit in the CSI request field indicates request for first set of serving cell, second bit indicates request for second set of serving cell, etc. wherein the sets of serving cells are configured by higher layer.
The first bit in the UE index field corresponds to first set of UEs and the second bit corresponds to second set of UEs, etc. A value ‘0’ means that UEs configured with corresponding UE index are not requested for CSI while a value ‘1’ means that UEs configured with corresponding UE index are requested for CSI for the sets of serving cells indicated by the CSI request field.

In such embodiments, the UE may be preferably configured with a RNTI csi request, UE index, and (sub)sets of serving cells.

Some of the approaches described modify existing, or define new, DCI formats in such a way that CSI-reports can be requested with better granularity and with more flexibility than previously possible. Many different sets, or subsets, of serving cells, as well as individual UEs, or subsets of UEs, can be polled for CSI.

Approaches described herein also facilitate requesting CSI from several UEs, or subsets of UEs, with a common grant, thus reducing the load on the (e)PDCCH.

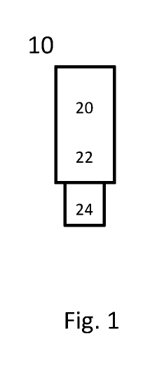

FIG. 1 schematically shows a terminal 10, which may in particular be implemented as a user equipment. Terminal 10 comprises control circuitry 20, which may comprise a controller connected to a memory. Any module of a terminal may implemented in and/or executable by, the terminal, in particular by and/or controlled by the control circuitry 20.

Terminal 10 also comprises radio circuitry 22 providing receiving and transmitting or transceiving functionality, the radio circuitry 22 connected or connectable to the control circuitry 20. An antenna circuitry 24 of the terminal 10 is connected or connectable to the radio circuitry 22 to collect or send and/or amplify signals. Radio circuitry 22 and the control circuitry 20 controlling it are configured for cellular communication and/or carrier aggregation, e.g. according to a configuration by the network or a radio node. The terminal 10 may be adapted to carry out any of the methods for operating a terminal disclosed herein; in particular, it may comprise corresponding circuitry, e.g. control circuitry. The terminal may in particular be adapted for LTE.

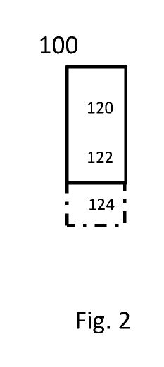

FIG. 2 schematically show a radio node 100, which may in particular be a network node or base station 100, in particular an eNodeB. Radio node 100 comprises control circuitry 120, which may comprise a controller connected to a memory. Any module of a radio node may be implemented in and/or executable by the radioi node, in particular the control circuitry 120. The control circuitry 120 is connected to control radio circuitry 122 of the network node 100, which provides receiver and transmitter and/or transceiver functionality. An antenna circuitry 124 may be connected or connectable to radio circuitry 122 for signal reception or transmittance and/or amplification. The radio node 100 may be adapted to carry out any of the methods for operating a radio node disclosed herein; in particular, it may comprise corresponding circuitry, e.g. control circuitry. The radio node may in particular be adapted for LTE.

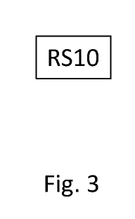

FIG. 3 shows an example for a method for operating a radio node in a wireless communication network. The method comprises an action RS10 of transmitting a carrier aggregate indication, CAI, indicating a carrier aggregation arrangement for measurement-related operation. The carrier aggregation arrangement represents a plurality of terminals configured for carrier aggregation and/or of at least one subset of a plurality of subsets of a set of carriers configured for carrier aggregation.

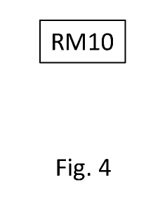

FIG. 4 shows an exemplary radio node for a wireless communication network, which may be any radio node described herein. The radio node comprises a transmitting module RM10 for performing action RS10.

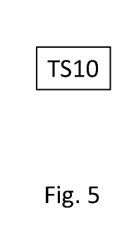

FIG. 5 shows an example for a method for operating a terminal in a wireless communication network. The method comprises an action TS10 of obtaining a carrier aggregate indication, CAI, indicating a carrier aggregation arrangement for measurement-related operation. The carrier aggregation arrangement represents a plurality of terminals configured for carrier aggregation and/or of at least one subset of a plurality of subsets of a set of carriers configured for carrier aggregation.

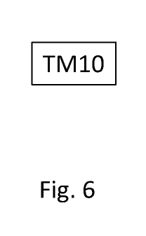

FIG. 6 shows an exemplary terminal for a wireless communication network, which may be any terminal described herein. The terminal comprises an obtaining module TM10 for performing action TS10.

In the context of this disclosure, at least one carrier may comprise at least one carrier accessed based on a LBT procedure (which may be called LBT carrier in the following), e.g. an unlicensed carrier. It may be considered that the carrier is part of a carrier aggregate.

A carrier aggregate may generally comprise a plurality of carriers, wherein one carrier may be a primary carrier and/or other carriers may be secondary carriers. A carrier in a carrier aggregate may be called component carrier (CC). It may be considered that carriers of a carrier aggregate are synchronized according to a pre-defined time structure and/or in relation to a synchronizing carrier, which may be a primary carrier. A primary carrier may be a carrier on which control information (e.g., like synchronization or timing information, e.g. information indicating timing advance) and/or scheduling data (allocating uplink and/or downlink resources) is transmitted and/or which carries one or more control channels for the carrier aggregate and/or one or more carriers. A carrier aggregate may comprise UL carrier/s and/or DL carrier/s. One or more carriers of a carrier aggregate may be unlicensed carriers (a carrier in an unlicensed spectrum may be considered an unlicensed carrier) and/or LBT carriers. It may be considered that a carrier aggregate additionally comprises one or more carriers for which no LBT procedure for access is performed, e.g. licensed carriers (a carrier in a licensed spectrum). A primary carrier may be such a carrier, in particular a licensed carrier. Accordingly, in some variants a carrier for which LBT is performed may be in a carrier aggregate comprising at least one carrier for which no LBT is performed, in particular a licensed carrier. A licensed carrier may generally be a carrier licensed for a specific Radio Access Technology (RAT), e.g. LTE.

A carrier may be associated to a characteristic frequency and/or a central frequency and/or a frequency range or bandwidth. It may be considered that a carrier comprises and/or is divided in one or more subcarriers, which may have associated to them each a bandwidth and/or a central. A carrier may be used for uplink (UL) and/or downlink (DL) communication, e.g. dependent on the Radio Access Technology (RAT) used, e.g. FDD (Frequency Division Duplex) or TDD (Time Division Duplkex), and/or (true) full duplex or half duplex. A carrier may comprise a continuous or discontinuous radio frequency bandwidth and/or frequency distribution, and/or may carry, and/or be utilized or utilizable for transmitting, information and/or signals, in particular communication data. It may be considered that a carrier is defined by and/or referred to and/or indexed according to for example a standard like LTE. A carrier may comprise one or more subcarriers. A set of subcarriers (comprising at least one subcarrier) may be referred to as carrier, e.g. if a common LBT procedure (e.g. measuring the total energy/power for the set) is performed for the set. A channel may comprise at least one carrier. Accessing a carrier may comprise transmitting on the carrier. If accessing a carrier is allowed, this may indicate that transmission on this carrier is allowed.

Transmission of data may be in uplink (UL) for transmissions from a terminal or user equipment to a base station (or radio node or network node or the network). Transmission of data may be considered in downlink (DL) for transmission from a base station/radio node/network to a terminal or user equipment. It may generally considered that any node in a network adapted to perform the functionality herein associated to a radio node is a radio node, regardless other functionality provided (or not provided) by the node.

A carrier may be a carrier of a carrier aggregate, in particular a secondary carrier. Alternatively or additionally, the carrier may be a LBT carrier and/or an unlicensed carrier. The term LAA (Licensed-Assisted Access) may generally refer to a carrier aggregation in which the primary carrier is a licensed carrier and at least one unlicensed carrier is a secondary carrier. Generally, the radio node may be adapted for LAA, and/or the carrier may be a secondary carrier of a LAA-CA.

An LBT procedure may comprise one or more Clear Channel Assessment (CCA, may also be called Clear Carrier Assessment) procedures). A CCA procedure may generally comprise sensing and/or determining the energy and/or power received on or for the channel or carrier (by the radio node) the LBT procedure is performed on over a time interval or duration, which may be called the CCA interval or duration. Generally, different CCA procedures may have different CCA intervals or durations, e.g. according to a configuration. The number of CCA procedure to be performed for a LBT procedure may be dependent on a random backoff counter. A CCA may indicate that a carrier or channel is idle if the power and/or energy sensed or determined is below a threshold, which may be a pre-determine threshold and/or be determined by the radio node, e.g. based on operating conditions and/or a configuration; if it is above or reaching the threshold, the carrier or channel may be indicated to be busy). A LBT procedure may be considered to determine that access to a carrier is allowed based on a number (e.g. a pre-determined number, e.g. according to a random backoff counter) of CCAs performed indicating that the carrier or channel is idle. In some cases, the number may indicate a number of consecutive indications of the carrier being idle. It may be generally considered that the radio node is adapted for such sensing and/or determining and/or for carrying out CCA, e.g. by comprising suitable sensor equipment and/or circuitry and/or a corresponding sensing module. Such a sensing module may be part of and/or be implemented as or in a LBT module. Performing a LBT procedure to determine whether accessing a carrier or channel is allowed may include performing one or more CCA procedures on that carrier or channel.

Configuring a terminal, in particular a user equipment, may refer to the terminal being adapted or caused or set to operate according to the configuration. Configuring may be done by another device, e.g. a radio node or network node (for example, a radio node of the network like a base station or eNodeB) or network, in which case it may comprise transmitting configuration data to the terminal to be configured. Such configuration data may represent the configuration to be configured and/or comprise one or more instructions and/or parameters pertaining to a configuration, in particular pertaining to a carrier aggregate for the terminal. A terminal or radio node may configure itself, e.g. based on configuration data received from a network or network node. A terminal configured with and/or for a carrier aggregate may be adapted or configured for communicating using the carrier aggregate.

Generally, configuring may include determining configuration data representing the configuration and providing it to one or more other nodes (parallel and/or sequentially), which may transmit it further to the radio node (or another node, which may be repeated until it reaches the wireless device). Alternatively or additionally, configuring a terminal, e.g. by a radio node or network node or other device, may include receiving configuration data and/or data pertaining to configuration data, e.g. from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g. an X2 interface in the case of LTE.

A storage medium may generally be computer-readable and/or accessible and/or readable by control circuitry (e.g., after connecting it to a suitable device or interface), and may comprise e.g. an optical disc and/or magnetic memory and/or a volatile or non-volatile memory and/or flash memory and/or RAM and/or ROM and/or EPROM and/or EEPROM and/or buffer memory and/or cache memory and/or a database and/or an electrical or optical signal.

An LAA node may be a radio node adapted for LAA.

In this description, for purposes of explanation and not limitation, specific details are set forth (such as particular network functions, processes and signaling steps) in order to provide a thorough understanding of the technique presented herein. It will be apparent to one skilled in the art that the present concepts and aspects may be practiced in other embodiments and variants that depart from these specific details.

For example, the concepts and variants are partially described in the context of Long Term Evolution (LTE) or LTE-Advanced (LTE-A) mobile or wireless communications technologies; however, this does not rule out the use of the present concepts and aspects in connection with additional or alternative mobile communication technologies such as the Global System for Mobile Communications (GSM). While the following embodiments will partially be described with respect to certain Technical Specifications (TSs) of the Third Generation Partnership Project (3GPP), it will be appreciated that the present concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the embodiments described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. Because the aspects presented herein can be varied in many ways, it will be recognized that any scope of protection should be defined by the scope of the claims that follow without being limited by the description.

A network node, e.g. a base station or eNodeB, may be adapted to provide and/or define and/or control one or more cells, e.g. a group of cells, which may be carrier aggregated (CA) cells. The group of cells may comprise at least one primary cell, which may be considered to be a member of the group and/or to be associated to the group. The cell group may comprise one or more secondary cells (it should be noted that every group may comprise secondary cells, not only a secondary group; the secondary in this context refers to being secondary to the primary cell of a group). A primary cell may be adapted and/or utilised for providing control information (in particular allocation data, and/or scheduling and/or allocation information regarding the primary cell and/or the group of cells to and/or from a terminal connected for communication (transmission and reception) and/or configured with the cell. The control information may pertain to the primary cell and/or the group of cells. Each primary cell and/or the associated group may be associated to a specific network node. A master network node may be adapted to provide and/or service and/or define a primary cell in a master cell group. A secondary network node may be adapted to provide and/or service and/or define a secondary cell group.

1. A method for operating a radio node in a wireless communication network, the comprising:
transmitting a carrier aggregate indication (CAI) indicating a carrier aggregation arrangement for measurement-related operation;
the carrier aggregation arrangement representing a plurality of terminals configured for carrier aggregation and/or at least one subset of a plurality of subsets of a set of carriers configured for carrier aggregation.

2. A method for operating a terminal in a wireless communication network, comprising:
obtaining a carrier aggregate indication (CAI) indicating a carrier aggregation arrangement for measurement-related operation,
the carrier aggregation arrangement representing a plurality of terminals configured for carrier aggregation and/or at least one subset of a plurality of subsets of a set of carriers configured for carrier aggregation.

3. A radio node for a wireless communication network, comprising:
at least one processor configured to transmit a carrier aggregate indication (CAI) indicating a carrier aggregation arrangement for measurement-related operation;
the carrier aggregation arrangement representing a plurality of terminals configured for carrier aggregation and/or at least one subset of a plurality of subsets of a set of carriers configured for carrier aggregation.

4. A terminal for a wireless communication network, comprising:
at least one processor configured to obtain a carrier aggregate indication (CAI) indicating a carrier aggregation arrangement for measurement-related operation,
the carrier aggregation arrangement representing a plurality of terminals configured for carrier aggregation and/or at least one subset of a plurality of subsets of a set of carriers configured for carrier aggregation.

5. The method of claim 1, wherein the set of carriers configured for carrier aggregation comprises 5 or more sets of carriers configured for carrier aggregation and/or wherein the CAI comprises 3 or more bits.

6. The method claim 1, wherein the set of carriers representing carriers is configured for one carrier aggregate and/or comprises sets with different types of carriers.

7. A computer readable medium storing instructions executable by control circuitry, wherein execution of the instructions causes the control circuitry to control and/or perform the method of claim 1.

8. (canceled)

9. The method of claim 2, wherein the set of carriers configured for carrier aggregation comprises 5 or more sets of carriers configured for carrier aggregation, and/or wherein the CAI comprises 3 or more bits.

10. The method of claim 2, wherein the set of carriers is configured for one carrier aggregate and/or comprises sets with different types of carriers.

11. The radio node of claim 3, wherein the set of carriers configured for carrier aggregation comprises 5 or more sets of carriers configured for carrier aggregation, and/or wherein the CAI comprises 3 or more bits.

12. The radio node of claim 3, wherein the set of carriers is configured for one carrier aggregate and/or comprises sets with different types of carriers.

13. The terminal of claim 4, wherein the set of carriers configured for carrier aggregation comprises 5 or more sets of carriers configured for carrier aggregation, and/or wherein the CAI comprises 3 or more bits.

14. The terminal of claim 4, wherein the set of carriers is configured for one carrier aggregate and/or comprises sets with different types of carriers.
